(19) United States
(12) Patent Application Publication
(10) Pub. No.: US 2012/0042700 A1
(43) Pub. Date: Feb. 23, 2012

(54) Security locking devices and/or sleeves

(76) Inventors: Neil Anthony Barron, Rhossili Swansea (GB); Nicolas John Howard Rawcliffe, Bispham Lancashire (GB); Thomas Pande, London (GB)

(21) Appl. No.: 13/138,633

(22) PCT Filed: Mar. 11, 2010
(86) PCT No.: PCT/GB2010/050431

§ 371 Date: Nov. 8, 2011

(30) Foreign Application Priority Data
Mar. 13, 2009 (GB) 0904367.0

(51) Int. Cl. E05B 73/00

(52) U.S. Cl. 70/15

(57) ABSTRACT

A security locking device comprises an elongate flexible strap and a lock; wherein said elongate flexible strap incorporates a flexible metallic portion; a synthetic fibre based portion; and a polymeric portion; said flexible synthetic fibre based portion having greater tensile strength than the other two portions; and said polymeric portion having greater elasticity than the other two portions.

### FIELD OF THE INVENTION

The invention relates to security locking devices and/or sleeves.

### BACKGROUND TO THE INVENTION

Despite the invention having applications beyond the field of bicycles and motorcycles as will be detailed in the description which follows, it stems from the field of bicycle and/or motorcycle locks. Therefore, existing bicycle and/or motorcycle locks constitute the closest known prior art to the invention.

Whilst hundreds of thousands of bicycles and tens of thousands of motorcycles are stolen in Britain every year, the development of locks for these follows a pattern of increased weight for stronger and more expensive locks. Due to the considerable weight of locks, the cyclist will usually have to stow the lock away in his/her back pack in order to cycle without the potential unbalance of otherwise having to hold the lock or secure the lock to one side of the handlebar. An alternative exists for certain bicycles which are equipped with a holder or a compartment for stowing the lock when it is not used for securing the bicycle to a given object. In this circumstance, the lock is sold as a kit in association with the holder which is secured to the bicycle frame. The lock is coated in a black material so as not to show grease marks and/or dirt which would end up on the exposed surface in the process of locking up and unlocking. A cyclist will often carry a cloth for wiping down his/her lock before stowing it away in order to try to prevent dirtying his/herself in the locking/unlocking process or the backpack or articles with which the lock would enter into contact.

Traditional locks can also often be abrasive at least in part and can therefore easily scratch surfaces against which they would enter into contact.

Furthermore, existing locks are usually bulky and relatively inflexible. These are also often formed of a polymeric layer on the outside with a metallic arrangement on the inside such as a chain. Any exposed metallic portion is particularly abrasive. Any improvement in the relative weight versus security ratio would therefore be significant taking into account the known art.

### SUMMARY OF THE INVENTION

In a first broad independent aspect, the invention provides a security locking device comprising an elongate flexible strap and a lock; wherein said elongate flexible strap incorporates a flexible metallic portion; a synthetic fibre based portion; and a polymeric portion; said flexible synthetic fibre based portion having greater tensile strength than the other two portions; and said polymeric portion having greater elasticity than the other two portions.

This configuration is particularly advantageous because it allows the weight/security ratio to be reduced. The strap for example, may be formed as a relatively flat strap instead of being circular in cross section as in the prior art. Due to the improvements to the weight/security ratio, the strap may be particularly easy to carry and may for example be worn across a cyclist's shoulder, neck and/or torso. It allows the security locking device to be particularly resistant to a combination of tools. It would for example be able to resist angle grinders, hammers, chisels, bolt croppers and/or saws.

In a subsidiary aspect, said polymeric portion is a silicone based portion. This would particularly improve the device's resistance to angle grinders, hammers and/or chisels.

In a further subsidiary aspect, said flexible synthetic fibre based portion comprises an aramid fibre. This may for example be a Kevlar. An arrangement of aramid fibres will have particularly high tensile strength which would allow the device to have improved resistance to the actions of for example croppers.

In a further subsidiary aspect, said flexible metallic portion may be selected to advantageously resist the abrasive action of a saw. In order to further improve the resistance to the actions of a saw, the flexible mechanic portion may incorporate metallic cables with one or more metallic tubes surrounding said cables. This would in effect cause the tubes to rotate around the cable. This would further prevent and/or resist sawing through the tube. In other words, it would have an effect similar to having placed a ball or a roller bearing around the cable.

In a further subsidiary aspect, the device further comprises an outer reflective layer. This marks a complete departure from the prior art thinking of necessarily selecting dark colours such as black for the security locking device. This would allow the device to be worn and therefore increase the overall visibility of the wearer.

In a further subsidiary aspect, the device further comprises a cushioning layer. This configuration also marks a departure from the conventional thinking of as a norm employing a rigid and constant diameter. This cushioning would allow a wearer to place with sufficient comfort the locking device around his/her shoulder. This would for example avoid having to rely on the cushioning provided by a back pack.

In a further subsidiary aspect, the device further incorporates a sleeve which in a first mode of use displays a first surface which is a reflective surface and in a second mode of use displays a second surface; whereby in a first mode of use said second surface is located inwardly relative to said first surface as the first surface is exposed and in a second mode of use said first surface is located inwardly relative to said second surface and said second surface is exposed. This allows the sleeve in a first mode of use to display a reflective surface in order to improve the visibility of the device. This may be particularly beneficial when worn by a cyclist. It also allows the sleeve to have a surface which may get dirty when the device is threaded through the spokes of a wheel for example, whilst this dirty surface may then be hidden away in another mode of use in order to prevent the grease or other dirt staining the garments of a wearer of the device.

In a further subsidiary aspect, said flexible metallic portion is located at an innermost location of said strap; said synthetic fibre based portion is located outwardly from said metallic portion; and said polymeric portion is located outwardly from said synthetic fibre based portion in this particular combination the device is particularly comfortable to wear and is also particularly resistant to severing attempts. It also allows the device to be particularly light weight for a particular security level.

In a further subsidiary aspect, said strap incorporates one or more lights. This configuration reverses conventional thinking in this field. It also allows the device to be worn with increased visibility.

In a further subsidiary aspect, said strap incorporates one or more pouches. This would allow a series of objects to be stowed away in the strap. Instead of in the prior art requiring both a backpack and a security locking device, this configuration may do away completely with the need for a backpack in certain circumstances.

In a further subsidiary aspect, said strap incorporates one or more magnets. These may be used to open and close sleeve portions. These may alternatively be provided to allow the strap to form different sizes of loops in order to increase the comfort of wearing the device. The magnets may also be placed in a position to allow a portion of the strap to be attracted to a metallic structure such as the bicycle frame and/or a lamppost.

In a further subsidiary aspect, said flexible metallic portion incorporates a mixture of steel and rubber. This configuration is particularly resistant to wear and tear. It also potentially reduces the number of components required to form the strap and therefore resulting in a more compact strap.

In a further subsidiary aspect, said lock incorporates a first and a second button; the first button having a projection and the second button having a recess; whereby the first button may be secured to the second button by inserting the projection into the recess. This configuration is particularly advantageous in terms of reducing and/or doing away altogether with any weak points.

In a further subsidiary aspect, at least one of said buttons incorporates one or more lights. This configuration allows the lighting system to be particularly secure whilst allowing the strap to retain its flexibility.

In a second broad independent aspect, the invention provides a sleeve sized and shaped to fit around a security locking device which in a first mode of use displays a first surface which is a reflective or a relatively high visibility surface and in a second mode of use, displays a second surface; whereby in a first mode of use said second surface is located inwardly relative to said first surface as the first surface is exposed and in a second mode of use said first surface is located inwardly relative to said second surface as the second surface is exposed. This configuration would allow the sleeve to fit around existing locks and chains and add comfort and wearability to these conventionally dirty, heavy and inflexible devices. It also allows these to be used to enhance the overall visibility of a cyclist. It would also allow the user to prevent dirt from locking/unlocking onto the bike from being transferred to clothing.

In a subsidiary aspect, the sleeve further incorporates a flexible metallic portion. This would allow the sleeve to further enhance the resistance of the lock incorporating a sleeve when subjected to the various tools mentioned above.

In a further subsidiary aspect, the sleeve further incorporates a synthetic fibre based portion. This configuration is particularly advantageous in terms of further strengthening a security locking device onto which the sleeve would be placed.

In a further subsidiary aspect, the sleeve further incorporates a polymeric portion. This would further improve the resistance to certain tools.

In a further subsidiary aspect, said polymeric portion is a silicone based portion. This would have the advantages listed above with reference to the security locking device.

In a further subsidiary aspect, said flexible synthetic fibre based portion comprises an aramid fibre. This configuration would also have the advantages detailed above.

In a further subsidiary aspect, said flexible metallic portion incorporates metallic cables with one or more metallic tubes surrounding said cables. This configuration would be particularly advantageous as detailed with reference to the security locking device above.

In a further subsidiary aspect, said sleeve further comprises a cushioning layer. This configuration attracts similar advantages as those detailed above.

In a further subsidiary aspect, the sleeve further comprises one or more lights. This configuration is particularly advantageous as detailed above with reference to the security locking device.

In a further subsidiary aspect, the sleeve further comprises one or more pouches. These have similar advantages as detailed above in the context of the security locking device.

In a further subsidiary aspect, the invention provides a sleeve incorporating one or more magnets. This configuration is also advantageous for the reasons detailed above with reference to the security locking device.

In a further subsidiary aspect, said flexible metallic portion incorporates a mixture of steel and rubber. This configuration is advantageous for the reasons detailed above with reference to the security locking device.

In a further subsidiary aspect, a sleeve further incorporates one or more holes through which a locking mechanism or a portion of a locking mechanism is placed, in use. This configuration allows the sleeve to be readily secured to a locking mechanism without requiring extra components to achieve the attachment.

In a further subsidiary aspect, said sleeve further incorporates a side opening and releasable attachment means for opening and closing said side opening. This configuration allows the sleeve to be readily wrapped around existing locks in order to allow these to be readily worn.

### BRIEF DESCRIPTION OF THE FIGURES

FIGS. 1A to 1D show respectively a silicone over-moulding (FIG. 1A), a Kevlar tube (FIG. 1B), a flexible metal inner structure (FIG. 1C), and the combination of the three components (FIG. 1D); each being shown in perspective view.

FIGS. 2A and B show respectively a view of an internal structure of a strap with a button closure mechanism (FIG. 2A); and a close up view of an extremity of the internal structure with the buttons (FIG. 2B); both of these are shown in perspective view.

FIG. 3 shows a perspective view of the security locking device of the embodiments of FIGS. 1 and 2.

FIGS. 4 show respectively a configuration in chevron form of cables and metal tubes in plan view (FIG. 4A); an arrangement of cables and tubes (FIG. 4B); and an arrangement with a number of hoops interconnected by tubes.

FIGS. 5 show respectively in perspective view a sleeve with releasable attachment means (FIG. 5A), a security strap with an integral sleeve (FIG. 5B), and a sleeve with a reinforced seem (FIG. 5C).

### DETAILED DESCRIPTION OF THE FIGURES

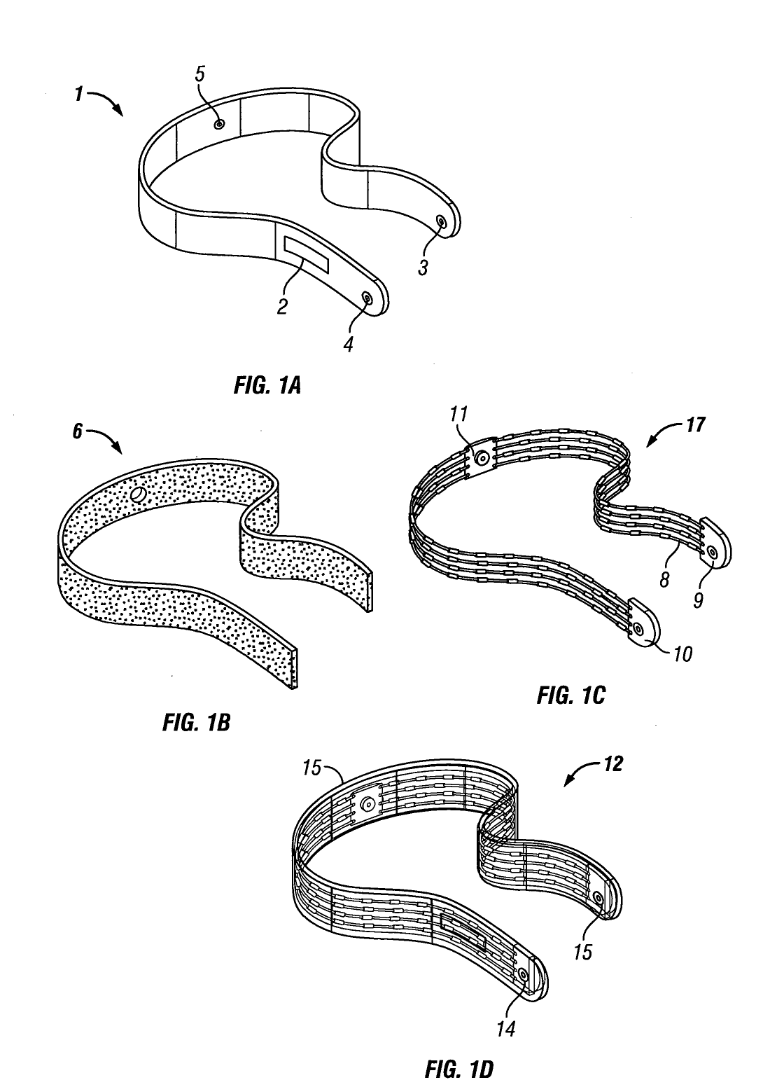

FIG. 1A shows a silicone over-moulding or outer portion generally referenced 1. The portion has a rectangular portion or an opening 2. A number of holes 3, 4 and 5 are provided at a plurality of locations which would allow the lock to be secured in different positions dependent upon the usage of the security locking device.

FIG. 1B shows a Kevlar tube generally referenced 6 which has a hollow portion to receive the flexible metallic portion 7. Whilst these are not shown, a number of holes may be provided to allow the threading through of a lock portion. Whist a Kevlar is the preferred aramid, other materials are envisaged. A mixture of Kevlar and other fibrous materials is also an option. Furthermore, if the fibres are to be fixed rather than flexible or if for example a portion of the strap is to be rigid, the fibres may be coated in a resin such as an epoxy resin.

FIG. 1C shows a flexible metallic inner structure formed from a number of cables such as cable 8. A number of holes 9, 10 and 11 are formed to correspond to the holes in the silicone over-moulding.

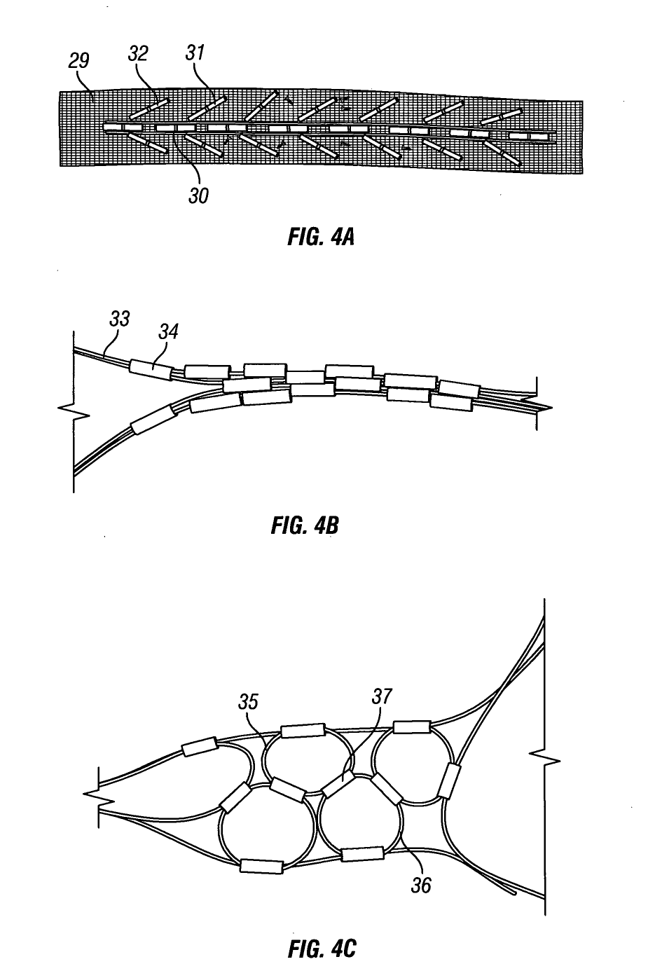

One preferred embodiment amalgamates the components of FIGS. 1A to 1C in a strap generally referenced 12 in FIG. 1D. This may be formed as a sandwich of materials. It may alternatively be formed as a concentric tube of materials. It may for example incorporate a cable structure inside a Kevlar woven tube. The invention also envisages that the cable is woven but not necessarily only along the length of a strap. Such structures are shown in the FIGS. 4A to 4C which follow.

The outer portion as shown in FIG. 1A may be of high visibility. It may also preferably have reflective properties of the kind found on bicycle reflectors.

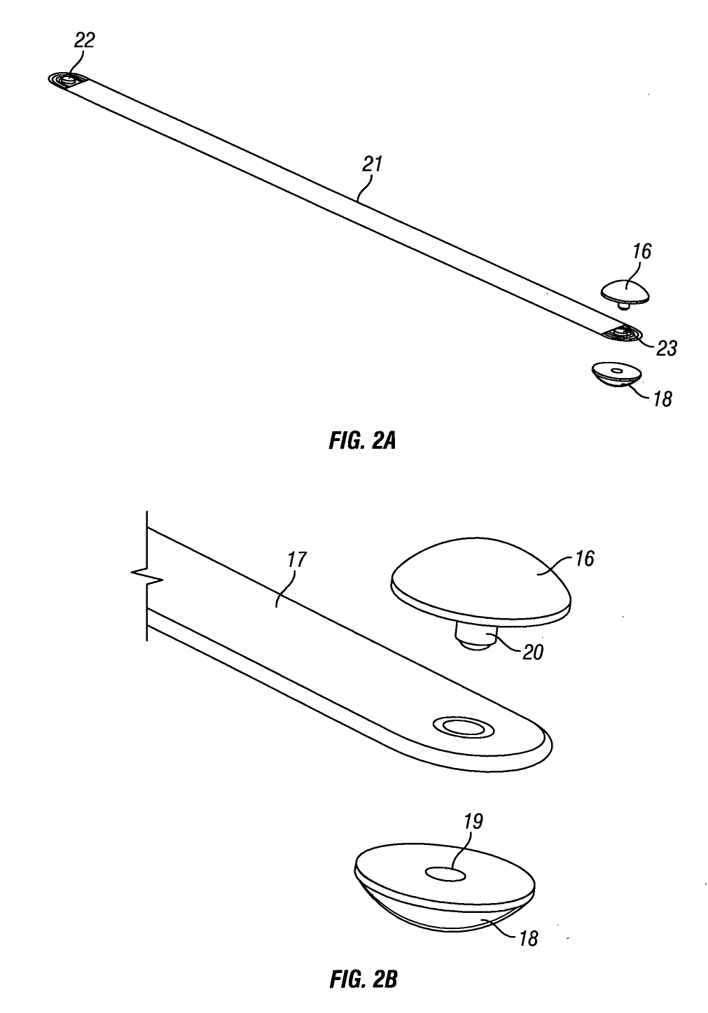

Strap 12 may form a closed loop by allowing a button or button arrangement of the kind shown in FIG. 2 to be fitted through one of the holes 13, 14 and 15. As shown in FIG. 2B a first button 16 is designed to fit against a portion of a strap 17 whilst a second button 18 fits against the opposite side of the strap. Button 18 incorporates a recess 19 configured to secure projection 20 of button 16. The buttons are dome shaped.

When the two buttons 16 and 18 are joined together these have the appearance of a yo-yo forming a padlock. The attachment mechanism is preferably hidden and has an integral connection with the internal structure 21 of the security locking device. The internal structure 21 incorporates a number of eyes 22 and 23 woven into the internal structure. FIG. 2A shows the internal structure with the Kevlar tube mentioned previously removed. There is also no plating and/or weaving and no spin bars shown whilst each one of these features may be incorporated. The internal structure may simply be the combination of steel and rubber such as that available from recycled vehicle tyres. The use of this recycled material has particular benefits to the environment and with regard to the overall cost and/or strength ratio of the security locking device.

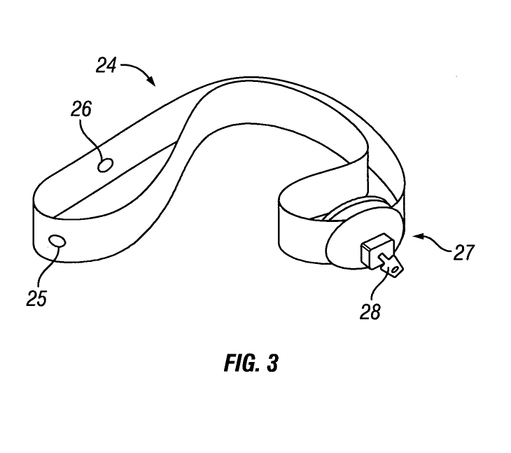

FIG. 3 shows a security locking device generally referenced 24. The strap may incorporate studs, holes and/or magnets at locations 25 and 26. The material used for the outer layer may be relatively shiny and of a bright yellow or orange colour. The lock generally referenced 27 may be opened and closed by a conventional key 28 in order to separate the two buttons in order to open the strap.

The structure shown in FIG. 3 may be compression moulded or extruded. The outer material may be silicone or a polychloroprene matrix containing or contained by a Kevlar continuously woven tubular sleeve with an internal cable structure onto which are mounted steel bushes which are free to rotate. The silicone resists the angle grinder, hammer and chisel. The Kevlar resists the bolt croppers. The steel components resist the saw. The lock is a so-called yo-yo shape with no exposed weak points. A further fabric or neoprene outer layer of a reflective kind may be added as well as lights and pouches. The strap may also preferably contain magnets. A preferred form of magnets would be Neodymium magnets.

FIG. 4A shows a woven material base 29 onto which a plurality of metallic cables such as cable 30 is secured. A number of laterally extending branches such as branch 31 are provided. At regular intervals around the cables there are provided bushes or tubes such as tube 32 which are free to rotate relative to the cables. In the embodiment of FIG. 4A the bushes are arranged to form a series of chevrons.

FIG. 4B shows an arrangement of cables 33 onto which bushes are located such as bush 34.

FIG. 4C shows a number of hoops of metallic material such as hoop 35 which is joined to a neighbouring hoop 36 via a bush 37.

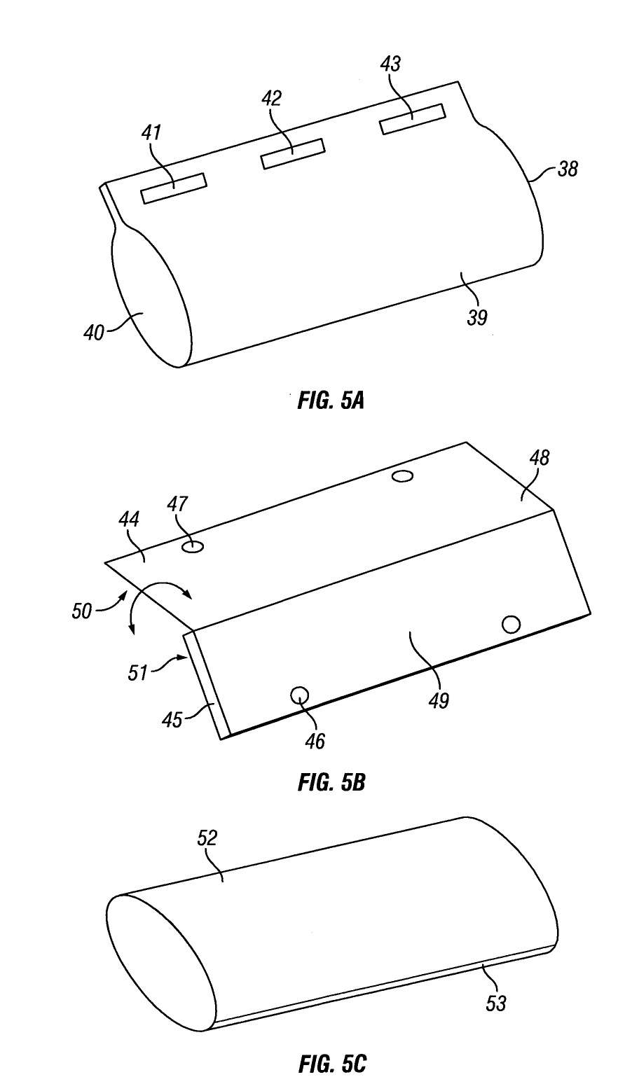

FIG. 5A shows a sleeve 38 of sufficient size to wrap around a portion of an existing lock and/or chain. The sleeve may be flexible and preferably of fabric in order to add to comfort and wearability. The outer surface 39 may be reflective or of high visibility such as a bright yellow. The internal surface of the sleeve may also be of high visibility or alternatively may be primarily designed for its washability. The sleeve is preferably reversible so that it can be opened and closed between two different positions. In a first position as shown in FIG. 5A, the outer surface is primarily reflective whilst the inner surface is of a non-reflective kind. Attachment means such as attachment means 41, 42 and 43 may be designed to open the sleeve laterally to allow the sleeve to readily fit onto a security locking device. The attachment means may incorporate magnets, a hook and eye arrangement and/or a filamentary hook and eye touch-to-close arrangement. Alternatively, the fabric may be sufficiently flexible inherently to allow the sleeve to be turned inside out to prevent dirt from locking/unlocking the bike from being transferred to clothing. This configuration would allow existing locks to be readily converted into a wearable high visibility sash.

Whilst a separable sleeve is envisaged as in FIG. 5A, a strap of the kind illustrated in the preceding Figures may incorporate an integral sheet 44 hinged relative to the strap 45. Attachment means such as attachment studs 46 and 47 would allow the sheet to be secured in a position to protect the high visibility surface. In this embodiment the high visibility surface would be on the exposed surfaces 48 and 49. When the strap is used as a lock it would simply require the high visibility surface to be hidden by folding surface 48 on to surface 49 and relying on the attachments 47 and 46 to allow the device to maintain its configuration. The surfaces 50 and 51 which during its locking mode would be exposed to dirt can be hidden as the sheet is secured by folding it back against surface 51. In this configuration, the security strap may readily be used against articles of clothing with little or no risk of them getting dirty.

FIG. 5C shows a sleeve 52 which may have a high visibility exposed surface and may be of sufficient size for attaching to existing locks and chains. In addition seam 53 may be reinforced by any of the features described above which reinforcements such as fibres and/or metallic cables.

The surface of the strap and/or sleeve may be of high visibility and/or reflective. It may have retro-reflective properties. It may be fluorescent. It may be of the kind complying with British Road standards for high visibility (for any of the available classes). It is preferred that they comply with any of classes 1 to 3 levels.

In further embodiments, the sleeve and/or the strap may incorporate a pocket sized and shaped for receiving a pump and/or a light or any other object of this kind.

In a further embodiment, lights may be built into the sleeve and/or strap and/or lock. In a particularly preferred embodiment, the padlock may have an integral light.

In a further embodiment, the outer cover may be interchangeable.

Whilst being particularly inventive in the field of bicycle locks, the invention may also be incorporated into any of the following:

A roof rack;

A bike rack;

A motorcycle lock;

A travel luggage lock;

A truck van and pickup ratchet strap type material;

Snap over lock clamps used for securing loads on trailers;

The lock may be shaped and configured to attach respectively to the steering wheel and the pedals in a car to stop them being stolen;

Lock for spare wheels on cars;

Domestic wheel clamp for car, trailer or caravan;

Inside rucksack straps so that the bag itself can be locked to something;

In the lining of a rucksack;

Flexible fences around property;

Roll-uppable window bars;

A 3-D structure such as a box whose walls have a structure of the kind use for the strap; This may for example be light weight, soft and safe;

Secure dog lead for anti-theft when the dog is locked up;

A boat lock; and

A tamper proof safety harness.

1-30. (canceled)

31. A security locking device comprising an elongate flexible strap and a lock;
wherein said elongate flexible strap incorporates a flexible metallic portion; a synthetic fibre based portion; and a polymeric portion; said flexible synthetic fibre based portion having greater tensile strength than the other two portions; and said polymeric portion having greater elasticity than the other two portions.

32. A device according to claim 31, wherein said polymeric portion is a silicone based portion.

33. A device according to claim 31, wherein said flexible synthetic fibre based portion comprises an aramid fibre.

34. A device according to claim 31, wherein said flexible metallic portion incorporates metallic cables with one or more metallic tubes surrounding said cables.

35. A device according to claim 31, wherein said flexible metallic portion incorporates a mixture of steel and rubber.

36. A device according to claim 31, wherein said flexible metallic portion is located at an innermost location of said strap; said synthetic fibre based portion is located outwardly from said metallic portion; and said polymeric portion is located outwardly from said synthetic fibre based portion.

37. A device according to claim 31, further incorporating a sleeve which in a first mode of use displays a first surface which is a reflective surface and in a second mode of use displays a second surface; whereby in a first mode of use said second surface is located inwardly relative to said first surface as the first surface is exposed and in a second mode of use said first surface is located inwardly relative to said second surface as said second surface is exposed.

38. A device according to claim 31, wherein said lock incorporates a first and a second button; the first button having a projection and the second button having a recess; whereby the first button may be secured to the second button by inserting the projection into the recess.

39. A sleeve sized and shaped to fit around a security locking device which in a first mode of use displays a first surface which is a reflective or a relatively high visibility surface and in a second mode of use displays a second surface; whereby in a first mode of use said second surface is located inwardly relative to said first surface as the first surface is exposed and in a second mode of use said first surface is located inwardly relative to said second surface as the second surface is exposed.

40. A sleeve according to claim 39, further incorporating a flexible metallic portion, a synthetic fibre based portion and a polymeric portion.

41. A sleeve according to claim 40, wherein said polymeric portion is a silicone based portion.

42. A sleeve according to claim 40, wherein said flexible synthetic fibre based portion comprises an aramid fibre.

43. A sleeve according to claim 40, wherein said flexible metallic portion incorporates metallic cables with one or more metallic tubes surrounding said cables.

44. A sleeve according to claim 40, wherein said flexible metallic portion incorporates a mixture of steel and rubber.

45. A sleeve according to claim 40, further incorporating one or more holes through which a locking mechanism or a portion of a locking mechanism is placed, in use.
